(19) United States
(12) Patent Application Publication
(10) Pub. No.: US 2006/0292441 A1
(43) Pub. Date: Dec. 28, 2006

(54) Cylindrical alkaline battery

(75) Inventors: Minajuro Ushijima, Osaka (JP); Noriyuki Ito, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD.

(21) Appl. No.: 11/472,468

(22) Filed: Jun. 22, 2006

(30) Foreign Application Priority Data
Jun. 24, 2005 (JP) 2005-184867

(51) Int. Cl. H01M 2/08; H01M 2/30

(52) U.S. Cl. 429/174; 429/181

(57) ABSTRACT

A cylindrical alkaline battery of the present invention includes a positive outer can in the form of a cylinder having a bottom and an opening at its top, a sealing member located along the inner edge of the opening, and a negative terminal for sealing the opening along with the sealing member. The negative terminal is caulked to the inner edge of the opening of the positive outer can via the sealing member. The positive outer can is formed of a metal plate including crystal grains with a grain size number of 9 to 12. A soft nickel-plating layer is deposited on both sides of the metal plate. The cylindrical alkaline battery further includes either or both of the following two configurations. Configuration 1: The surface roughness Ra of a portion of the positive outer can that comes into contact with the sealing member is 2 or less. Configuration 2: In the portion of the positive outer can that comes into contact with the sealing member, there are exposed portions of the metal plate due to cracks of the soft nickel-plating layer in the direction of the cylinder axis of the positive outer can, and the width of the exposed portions of the metal plate in the direction perpendicular to the cylinder axis is 100 μm or less.

### BACKGROUND OF THE INVENTION

1. Field of the Invention

The present invention relates to an alkaline battery with a cylindrical shape.

2. Description of Related Art

In an alkaline battery having an alkaline electrolytic solution, a positive outer can (battery can) serves as an outer package of the battery and also functions as a positive terminal. For example, the positive outer can is made of a nickel-plated steel plate obtained by coating both sides of a steel plate with nickel. As the nickel coating of the nickel-plated steel plate, a so-called hard nickel plating has been used (see, e.g., JP 5(1993)-21044 A).

However, studies conducted by the present inventors showed that when the positive outer can of an alkaline battery was made of a nickel-plated steel plate with such a hard nickel-plating layer (hard nickel-plated steel plate), the battery characteristics were degraded during long-term storage. To increase the hardness of the nickel-plating layer, the hard nickel-plated steel plate contains P (phosphorus) or S (sulfur) as a component for hardening the nickel-plating layer. However, P or S increases the resistance value of the battery during storage, and thus may cause degradation of the battery characteristics.

Under these circumstances, the present inventors started to develop an alkaline battery that can suppress degradation of the battery characteristics, even if the battery is stored over a long period of time, by using a soft nickel-plated steel plate. The soft nickel-plated steel plate has a so-called soft nickel-plating layer on both sides and contains few or substantially no hardening component such as P or S.

However, further studies revealed that when the positive outer can of an alkaline battery was made of a soft nickel-plated steel plate, a leakage of the alkaline electrolytic solution was likely to occur. The electrolytic solution leaking from the alkaline battery may damage equipment that incorporates the alkaline battery. Therefore, leakage resistance is one of the basic characteristics of the alkaline battery.

### SUMMARY OF THE INVENTION

A first cylindrical alkaline battery of the present invention includes the following: a positive outer can in the form of a cylinder having a bottom and an opening at its top; a sealing member located around the inside edge of the opening; and a negative terminal for sealing the opening along with the sealing member. The positive outer can houses electric power generating elements. The negative terminal is caulked to the inside edge of the opening of the positive outer can via the sealing member. The positive outer can is formed of a metal plate including crystal grains with a grain size number of 9 to 12. A soft nickel-plating layer is deposited on both sides of the metal plate. The surface roughness Ra of a portion of the positive outer can that comes into contact with the sealing member is 2 or less.

A second cylindrical alkaline battery of the present invention includes the following: a positive outer can in the form of a cylinder having a bottom and an opening at its top; a sealing member located around the inside edge of the opening; and a negative terminal for sealing the opening along with the sealing member. The positive outer can houses electric power generating elements. The negative terminal is caulked to the inside edge of the opening of the positive outer can via the sealing member. The positive outer can is formed of a metal plate including crystal grains with a grain size number of 9 to 12. A soft nickel-plating layer is deposited on both sides of the metal plate. In a portion of the positive outer can that comes into contact with the sealing member, there are exposed portions of the metal plate due to cracks of the soft nickel-plating layer in the direction of the cylinder axis of the positive outer can, and the width of the exposed portions of the metal plate in the direction perpendicular to the cylinder axis is 100 μm or less.

A third cylindrical alkaline battery of the present invention includes the following: a positive outer can in the form of a cylinder having a bottom and an opening at its top; a sealing member located around the inside edge of the opening; and a negative terminal for sealing the opening along with the sealing member. The positive outer can houses electric power generating elements. The negative terminal is caulked to the inside edge of the opening of the positive outer can via the sealing member. The positive outer can is formed of a metal plate including crystal grains with a grain size number of 9 to 12. A soft nickel-plating layer is deposited on both sides of the metal plate. The surface roughness Ra of a portion of the positive outer can that comes into contact with the sealing member is 2 or less. In the portion of the positive outer can that comes into contact with the sealing member, there are exposed portions of the metal plate due to cracks of the soft nickel-plating layer in the direction of the cylinder axis of the positive outer can, and the width of the exposed portions of the metal plate in the direction perpendicular to the cylinder axis is 100 μm or less.

### BRIEF DESCRIPTION OF THE DRAWINGS

FIG. 1 is a cross-sectional view showing an example of a cylindrical alkaline battery of the present invention.

FIG. 2 is an enlarged view showing the main parts in FIG. 1.

FIG. 3 is an electron micrograph showing a portion of a positive outer can that comes into contact with a sealing member used in an alkaline battery of Example 3.

FIG. 4 is an electron micrograph showing a portion of a positive outer can that comes into contact with a sealing member used in an alkaline battery of Comparative Example 1.

### DETAILED DESCRIPTION OF THE INVENTION

A cylindrical alkaline battery of the present invention includes a positive outer can in the form of a cylinder having a bottom and an opening at its top, a sealing member located around the inside edge of the opening, and a negative terminal for sealing the opening along with the sealing member. The positive outer can houses electric power generating elements. The negative terminal is caulked to the inside edge of the opening of the positive outer can via the sealing member. The positive outer can is formed of a metal plate including crystal grains with a grain size number of 9 to 12. A soft nickel-plating layer is deposited on both sides of the metal plate.

The cylindrical alkaline battery further includes either or both of the following two configurations.

Configuration 1: The surface roughness Ra of a portion of the positive outer can that comes into contact with the sealing member is 2 or less.

Configuration 2: In the portion of the positive outer can that comes into contact with the sealing member, there are exposed portions of the metal plate due to cracks of the soft nickel-plating layer in the direction of the cylinder axis of the positive outer can, and the width of the exposed portions of the metal plate in the direction perpendicular to the cylinder axis is 100 μm or less.

In the present invention, the positive outer can is formed of a metal plate having a soft nickel-plating layer on both sides (i.e., double-sided soft nickel-plated metal plate). The soft nickel-plating layer contains few or substantially no element such as P or S. This prevents an increase in the resistance value of the battery caused by P or S during storage, and thus can suppress degradation of the battery characteristics. Specifically, P and S contained in the soft nickel-plating layer are each not more than 100 ppm by mass.

Although a positive outer can made of the double-sided soft nickel-plated metal plate tends to cause a leakage of the alkaline electrolytic solution, the present invention can suppress the leakage in the following manner. The metal plate used for the double-sided soft nickel-plated metal plate includes crystal grains with a specific grain size number (G. S. No.) to prevent a surface defect from occurring during formation of the positive outer can, and the surface properties of the opening of the positive outer can is controlled to improve hermetic sealing of the battery.

In the present invention, the G. S. No. of the crystal grains was measured by a method based on E-112 (standard test methods for determining average grain size) of ASTM (American Society for Testing and Materials) with an intercept count on 500 mm test pattern.

In the present invention, the surface roughness Ra of the portion of the positive outer can that comes into contact with the sealing member indicates the centerline average roughness defined by the Japanese Industrial Standards (JIS) B 0601. Specifically, the centerline average roughness was measured with a surface roughness measuring device (“Surftest SJ-201” manufactured by Mitsutoyo Corporation) at 0.8 mm cutoff.

In the present invention, the width of the exposed portions of the metal plate indicates the maximum width of the exposed portions of the metal plate in the direction perpendicular to the cylinder axis of the positive outer can in the portion of the positive outer can that comes into contact with the sealing member.

The material of the metal plate is not particularly limited, but preferably is a metal to be drawn easily, such as an iron plate, a steel plate, or a stainless steel plate. There is also no particular limitation to the shape and material of the negative terminal. The negative terminal generally is in the form of a plate, and the same materials as those for the metal plate can be used.

The sealing member may be made of any material, and generally resin. The suitable resin for the sealing member should have high elasticity and high insulating properties, e.g., a polyamido resin such as nylon 66. The electric power generating elements include a positive electrode, a negative electrode, a separator, and an electrolytic solution.

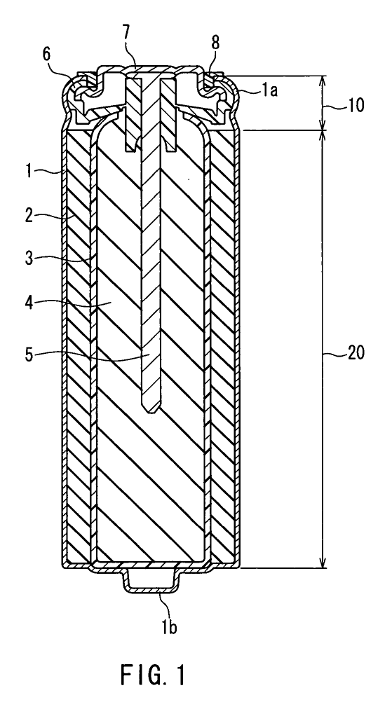

Hereinafter, the present invention will be described by way of illustrative embodiments with reference to the drawings. FIG. 1 is a cross-sectional view showing an example of a cylindrical alkaline battery of the present invention. As shown in FIG. 1, the cylindrical alkaline battery includes a positive outer can 1 formed of a steel plate having a soft nickel-plating layer (not shown) on both sides. A cylindrically molded positive electrode 2 (molded positive mixture) is placed in the positive outer can 1. A cup-shaped separator 3 is placed inside the positive electrode 2, and an alkaline electrolytic solution (not shown) is injected into the separator 3. Moreover, the separator 3 is filled with a negative electrode 4 (gel negative mixture) including zinc or zinc alloy powder. A positive terminal 1b is provided at the bottom of the positive outer can 1. A negative terminal plate 7 made of metal such as nickel-plated iron or stainless steel is put at an open end 1a of the positive outer can 1. The negative terminal plate 7 is caulked to the inside edge of the open end 1a via a sealing member 6 made of resin. An insulator 8 made of resin is arranged between the positive outer can 1 and the negative terminal plate 7 for insulation purposes. A negative current collector 5 made of metal such as tinned brass is inserted into the negative electrode 4 with its upper portion welded to the negative terminal plate 7. In FIG. 1, reference numeral 10 denotes a sealing portion, and 20 denotes a body of the cylindrical alkaline battery.

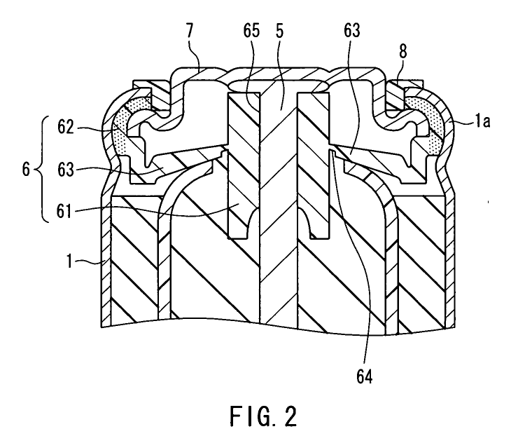

FIG. 2 is an enlarged view showing the sealing portion 10 and its vicinity of the cylindrical alkaline battery of FIG. 1. In FIG. 2, the same components as those in FIG. 1 are denoted by the same reference numerals, and in some cases, the explanation will not be repeated. A peripheral portion 62 of the sealing member 6 is present between the open end 1a of the positive outer can 1 and the negative terminal plate 7, and the open end 1a is bent inward and sealed. To facilitate the understanding of contact between the positive outer can 1 and the sealing member 6, a portion of the sealing member 6 that touches the positive outer can 1, i.e., the peripheral portion 62 is dotted in FIG. 2. The negative terminal plate 7 is shaped so that the end portion fits sufficiently to support the sealing member 6. The negative current collector 5 is welded to the negative terminal plate 7 and inserted into the negative electrode 4 through a hole 65 that is formed in a boss 61 of the sealing member 6. A connecting portion 63 connects the boss 61 and the peripheral portion 62 of the sealing member 6. The connecting portion 63 has an explosion-proof thin portion 64. For example, when the battery is short-circuited and gas is generated rapidly in the battery, the thin portion 64 is broken preferentially and allows the gas to flow toward the negative terminal plate 7. There is a vent (not shown) in the negative terminal plate 7. Therefore, the gas in the battery is discharged to the outside through the vent, which can prevent expansion or rupture of the battery at the time of a short circuit.

In this embodiment, the positive outer can 1 is formed of a steel plate having a soft nickel-plating layer on both sides. As described above, the soft nickel-plating layer contains substantially no element such as P or S. That is, the soft nickel plating of this embodiment is not general nickel plating (so-called hard nickel plating) represented by alloy plating containing P or S as a trace element. A typical example of the soft nickel plating may be dull nickel plating using a plating solution that does not include any organic addition agent such as a brightener, a leveling agent, or a pinhole inhibiter.

The general hard nickel plating, which is called “bright nickel plating” or “semi-bright nickel plating”, contains a very small amount of components such as P or S to produce harder and brighter coatings. These components increase the resistance value of the battery during long-term storage. In this embodiment, therefore, the soft nickel plating that contains substantially no element such as P or S is applied to both sides of the steel plate of the positive outer can, thus suppressing degradation of the battery characteristics during long-term storage. In the context of the present invention, “including substantially no element such as P or S” indicates a permissible amount of P or S that is contained unavoidably in the nickel-plating layer during or after deposition. Specifically, P and S contained in the soft nickel-plating layer are each not more than 100 ppm by mass.

For a steel plate coated with conventional hard nickel plating, the nickel-plating layer is hard, and therefore likely to peel off the steel plate and also to generate cracks. Thus, the hard nickel-plated steel plate used for the positive outer can of a general battery is heat-treated after depositing the nickel-plating layer, so that a region where Ni and Fe are diffused (Ni—Fe diffusion layer) is provided in the vicinity of the boundary between the nickel-plating layer and the steel plate. This can improve the adhesion between the nickel-plating layer and the steel plate and suppress peeling or cracking of the nickel-plating layer. In contrast, the battery of this embodiment uses the double-sided soft nickel-plated steel plate for the positive outer can. Since the nickel-plating layer is soft, it neither peels off nor cracks easily. Thus, the soft nickel-plated steel plate does not require a heat treatment to form a conventional Ni—Fe diffusion layer. This can improve the productivity of the positive outer can, which in turn improves the productivity of the battery. In other words, the positive outer can of the battery in this embodiment may be made of a double-sided soft nickel-plated steel plate that has substantially no Ni—Fe diffusion layer at the boundary between the nickel-plating layer and the steel plate. In the context of the present invention, “having substantially no Ni—Fe diffusion layer” is intended to exclude a Ni—Fe diffusion layer that is formed actively by heat treatment or the like, while allowing a diffusion region of Ni and Fe to be generated unavoidably at the boundary between the soft nickel-plating layer and the steel plate when the soft nickel-plating layer is deposited on the surface of the steel plate.

In the battery of this embodiment, the G. S. No. of the crystal grains of the double-sided soft nickel-plated steel plate for the positive outer can is 9 to 12, and preferably 9 to 10. The double-sided soft nickel-plated steel plate having a G. S. No. of 9 to 12 exhibits good press formability, and thus can suppress a surface defect that may lead to a leakage of the alkaline electrolytic solution during formation of the positive outer can. Accordingly, the battery of this embodiment can suppress a leakage of the alkaline electrolytic solution.

The G. S. No. of the double-sided soft nickel-plated steel plate of the positive outer can falls within the above range by simply depositing a soft nickel-plating layer on both sides of a steel plate that includes crystal grains with a G. S. No. of 9 to 12. The double-sided soft nickel-plated steel plate thus obtained can be shaped into the positive outer can, e.g., by ordinary drawing.

In the battery of this embodiment, the portion of the positive outer can 1 that comes into contact with the sealing member 6 (i.e., the inner surface of the positive outer can 1 that is in contact with the dotted peripheral portion 62 of the sealing member 6 in FIG. 2) has Configuration 1 and/or Configuration 2.

As shown in FIGS. 1 and 2, the peripheral portion 62 of the sealing member 6 is present between the open end 1a of the positive outer can 1 and the negative terminal plate 7, the open end 1a is bent inward, and the outer surface of the peripheral portion 62 is brought into contact with the inner surface of the open end 1a of the positive outer can 1, thereby sealing the battery. The alkaline electrolytic solution is most likely to leak from where the open end 1a of the positive outer can 1 and the peripheral portion 62 of the sealing member 6 are in contact. Therefore, this embodiment specifies not only the G. S. No. of the crystal grains of the steel plate of the positive outer can 1 for eliminating a surface defect, but also the surface properties of the inner surface of the positive outer can 1 that comes into contact with the sealing member 6. As a result of a synergistic effect of these configurations, a leakage of the alkaline electrolytic solution can be suppressed successfully.

In this embodiment, the surface roughness Ra of the portion of the positive outer can 1 that comes into contact with the sealing member 6 is 2 or less, and preferably 1.5 or less. When the inner surface of the positive outer can 1 (i.e., the surface of the soft nickel-plating layer inside the battery) that comes into contact with the sealing member 6 has the above surface roughness, a leakage of the alkaline electrolytic solution can be suppressed. Although the surface roughness Ra should be as small as possible in terms of suppression of the leakage, it is difficult to avoid an increase in the surface roughness Ra during processing of the positive outer can 1. Thus, the lower limit of the surface roughness Ra is, e.g., 0.05. Accordingly, the surface roughness Ra may be 0.05 to 2, and preferably 0.05 to 1.5.

The surface roughness of one surface of the double-sided soft nickel-plated steel plate that is to be the inner surface of the positive outer can (the battery) may change when the soft nickel-plated steel plate is shaped into the positive outer can by ordinary drawing, but hardly changes when it is further processed into the battery. Therefore, the surface roughness Ra of the portion of the positive outer can that comes into contact with the sealing member falls within the above range by using a positive outer can in which the surface roughness Ra of at least the inner surface is, e.g., 2 or less. Such a positive outer can may be made of a double-sided soft nickel-plated steel plate that includes a steel plate with a G. S. No. of 9 to 12 and a soft nickel-plating layer deposited on both sides of the steel plate. A ratio of the thickness of the steel plate to the thickness of the soft nickel-plating layer is 3000:1 to 1000:3. The surface roughness Ra of the soft nickel-plating layer of the double-sided soft nickel-plated steel plate is smaller than the desired surface roughness Ra of the portion of the positive outer can that comes into contact with the sealing member. This double-sided soft nickel-plated steel plate can be deep-drawn in the same way as a conventional technique. The soft nickel-plating layer of the double-sided soft nickel-plated steel plate before being shaped into the positive outer can preferably has a surface roughness Ra of 0.05 to 0.3.

Moreover, in the portion of the positive outer can 1 that comes into contact with the sealing member 6, there are exposed portions of the steel plate due to cracks of the soft nickel-plating layer in the direction of the cylinder axis of the positive outer can 1, and the width of the exposed portions of the steel plate in the direction perpendicular to the cylinder axis is 100 μm or less, and preferably 50 μm or less. When the inner surface of the positive outer can 1 (i.e., the surface of the soft nickel-plating layer inside the battery) that comes into contact with the sealing member 6 has the exposed portions of the steel plate due to cracks of the soft nickel-plating layer in the direction of the cylinder axis of the positive outer can 1, and the width of the exposed portions of the steel plate in the direction perpendicular to the cylinder axis is controlled to not more than the above upper limit, a leakage of the alkaline electrolytic solution can be suppressed.

The width of the exposed portions of the steel plate should be as small as possible in terms of suppression of the leakage. However, if the width is too small, the conductivity between the positive outer can 1 and the positive electrode 2 may be reduced. Therefore, the preferred lower limit of the width is, e.g., 10 μm.

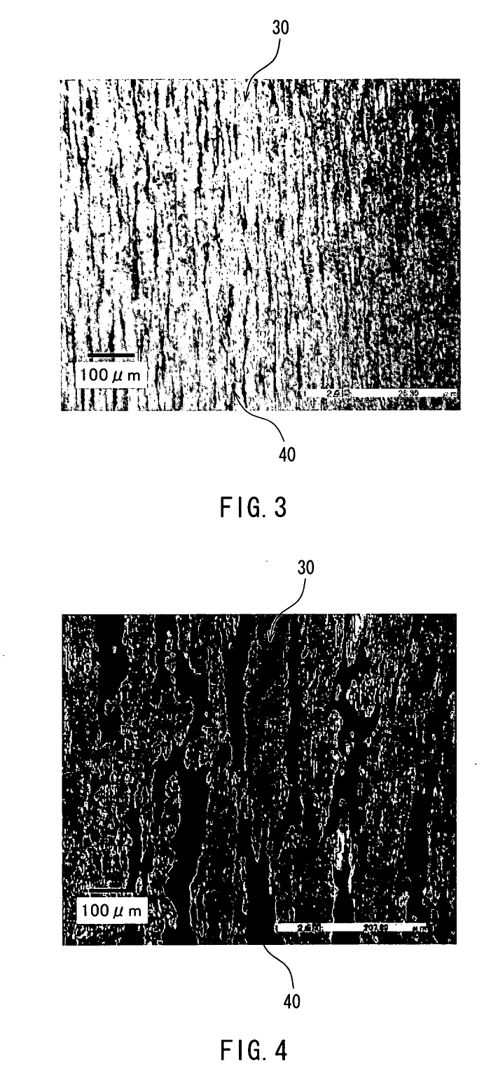

FIG. 3 is an electron micrograph (magnification: 100×) showing the portion of the positive outer can that comes into contact with the sealing member used in a battery of Example 3 of the present invention, which will be described later. FIG. 4 is an electron micrograph (magnification: 100×) showing the portion of the positive outer can that comes into contact with the sealing member used in a battery of Comparative Example 1, which will be described later. As described above, the width of the exposed portions of the steel plate indicates the maximum width of the exposed portions of the steel plate in the direction perpendicular to the cylinder axis of the positive outer can in the portion of the positive outer can that comes into contact with the sealing member. In FIGS. 3 and 4, the vertical direction of the photographs corresponds to the direction of the cylinder axis of the positive outer can, and the exposed portions of the steel plate generally are present along the direction of the cylinder axis, as shown in the photographs. The “width of the exposed portions of the steel plate” means the maximum width (length) in the direction perpendicular to the cylinder axis (i.e., the direction parallel to the horizontal direction of the photographs). Specifically, the width of the exposed portions of the steel plate in the present invention was measured by surface observation (magnification: 500×) with a microscope.

The exposed portions of the steel plate on one surface of the double-sided soft nickel-plated steel plate that is to be the inner surface of the positive outer can (the battery) are generated when the soft nickel-plated steel plate is shaped into the positive outer can by general drawing, but hardly generated in the subsequent processes (e.g., assembly of the battery). Therefore, the width of the exposed portions of the steel plate present in the portion of the positive outer can that comes into contact with the sealing member falls within the above range by using a positive outer can in which the width of the exposed portions of the steel plate on at least the inner surface is, e.g., 100 μm or less. Such a positive outer can may be made of a double-sided soft nickel-plated steel plate that includes a steel plate with a G. S. No. of 9 to 12 and a soft nickel-plating layer deposited on both sides of the steel plate. A ratio of the thickness of the steel plate to the thickness of the soft nickel-plating layer is 3000:1 to 1000:3. This double-sided soft nickel-plated steel plate can be deep-drawn in the same way as a conventional technique. The double-sided soft nickel-plated steel plate before being shaped into the positive outer can may have no exposed portion of the steel plate on the surface.

In the positive outer can 1 of this embodiment, the thickness of the steel plate portion and the thicknesses of the soft nickel-plating layers of the inner and outer surfaces are not particularly limited and may be determined appropriately in accordance with the size or application of the battery. For example, in the case of an AA-size battery, it is preferable that the steel plate portion has a thickness of 0.1 to 0.3 mm, and the soft nickel-plating layers of the inner and outer surfaces have a thickness of 1 to 3 μm, respectively.

In a conventional alkaline battery that includes a positive outer can made of a hard nickel-plated steel plate, the nickel-plating layer of the inner surface of the battery is made relatively thin (e.g., about 0.5 to 1 μm) in general, so that the nickel-plating layer can develop some cracks to ensure the conductivity between the positive outer can and the positive electrode. However, if the nickel-plating layer of the outer surface of the battery cracks and the steel plate is exposed, it may be corroded by moisture in the atmosphere. Therefore, the nickel-plating layer of the outer surface is made thick (e.g., 2 to 3 μm) to suppress the generation of cracks. In contrast, the battery of this embodiment includes the positive outer can that is formed of a steel plate having a soft nickel-plating layer that is not likely to crack on both sides. Thus, even if the soft nickel-plating layer has such a small thickness as described above particularly on the outer surface of the battery, the generation of cracks can be suppressed, resulting in good corrosion resistance. Consequently, this embodiment can achieve cost reduction by thinning the nickel-plating layer and improve the productivity further.

In the cylindrical alkaline battery of this embodiment, the components other than the positive outer can are not particularly limited, and various kinds of components used in a conventional cylindrical alkaline battery may be used.

Negative Electrode

The negative electrode may be a gel negative mixture that includes zinc particles or zinc alloy particles (both are referred to as “zinc-based particles” in the following), an alkaline electrolytic solution, and a gelling agent. In the negative mixture, a zinc component of the zinc-based particles acts as an active material.

To suppress the generation of a gas by a reaction of the negative active material and the electrolytic solution, it is preferable that the zinc-based particles are zinc alloy particles including indium, bismuth, or aluminum as alloy components. The content of these elements in the zinc alloy particles may be, e.g., 0.02 to 0.07 mass % of indium, 0.007 to 0.025 mass % of bismuth, and 0.001 to 0.004 mass % of aluminum. The zinc alloy particles may include the alloy components either individually or in combinations of two or more. The other components of the zinc alloy particles are, e.g., zinc and unavoidable impurities.

The zinc-based particles for the negative electrode may be in any form, and desirably fine particles in which the proportion of the particles that can pass through a 200-mesh sieve is 40 mass % or more, preferably 50 mass % or more, and further preferably 55 mass % or more. When the zinc-based particles include such fine particles in a proportion of not less than the above lower limit, the specific surface area of the whole negative active material is increased, so that the reaction in the negative electrode can proceed efficiently. Thus, the load characteristics of the battery can be improved.

The electrolytic solution for the negative electrode is preferably an aqueous solution of a hydroxide of alkali metal (such as sodium hydroxide, potassium hydroxide, or lithium hydroxide), and more preferably an aqueous solution of potassium hydroxide. In the case of the aqueous solution of potassium hydroxide, it is preferable that the concentration of potassium hydroxide is 38 mass % or less. The potassium hydroxide concentration is more preferably 35 mass % or less, and further preferably 33.5 mass % or less, since the ionic conductance of the electrolytic solution is increased to enhance the reactivity of the negative electrode, and thus can improve the load characteristics of the battery and easily provide the effect of suppressing heat generation when the battery is short-circuited.

When the aqueous solution of potassium hydroxide is used as the electrolytic solution, the higher the potassium hydroxide concentration is, the smaller the degradation of the battery characteristics becomes during storage. Therefore, the potassium hydroxide concentration is preferably 28 mass % or more, and more preferably 30 mass % or more.

The gelling agent for the negative electrode may be, e.g., polyacrylic acids (such as polyacrylic acid, polyacrylic soda, or ammonium polyacrylate) or celluloses (such as carboxymethyl cellulose (CMC), methylcellulose, hydroxypropylcellulose, or alkali salts thereof). As disclosed in JP 2001-307746 A, a crosslinked polyacrylic acid or its hydrophilic polymer salt (such as polyacrylic soda or ammonium polyacrylate) may be used with other gelling agents. Examples of the gelling agents that can be used with the crosslinked polyacrylic acid or its hydrophilic polymer salt include the above celluloses and a crosslinked branched polyacrylic acid or its salt (such as soda salt or ammonium salt). The crosslinked polyacrylic acid or its hydrophilic polymer salt may be spherical in shape and have an average grain size of 10 to 100 μm.

The contents of the zinc-based particles, the electrolytic solution, and the gelling agent in the negative mixture may be, e.g., 50 to 75 mass %, 25 to 50 mass %, and 0.01 to 1.0 mass %, respectively.

The negative mixture also may include a small amount of indium compound (indium oxide) or bismuth compound (bismuth oxide). These compounds are effective in suppressing the generation of a gas by a corrosion reaction of the zinc-based particles and the electrolytic solution. However, if the compounds are included excessively, the load characteristics of the battery may be reduced. Therefore, it is preferable to determine the content as needed without posing such a problem. For example, the content of each of the indium compound and the bismuth compound may range from about 0.003 to 0.05 parts by mass per 100 parts by mass of the zinc-based particles.

Positive Electrode

The positive electrode used in this embodiment may be produced generally by mixing manganese dioxide or nickel oxyhydrooxide (active material), a conductive agent, and an electrolytic solution and a binder for enhancing the formability, and press-molding the resultant positive mixture into a hollow cylinder or the like.

The positive active material may have a BET specific surface area of 40 to 100 m²/g. If the BET specific surface area is too small, although the formability is good, the reaction efficiency becomes poor because of a smaller reaction area, and the effect of improving the load characteristics may be reduced. If the BET specific surface area is too large, although the reaction efficiency is increased, the formability may be reduced because of a lower bulk density. Therefore, the positive active material preferably has a BET specific surface area of 45 to 60 m²/g so as to improve the formability and further increase the strength of the molded positive mixture.

In this embodiment, the BET specific surface area of the positive active material was measured and calculated with a BET equation, which is a theoretical formula of multilayer adsorption, and indicates the specific surface area of the surface and micropores of the active material. Specifically, the BET specific surface area was determined by using a specific surface area measuring device (“Macsorb HM model-1201” manufactured by Mountech Co., Ltd.) with a nitrogen adsorption method.

It is desirable that manganese dioxide used as the positive active material contain 0.01 to 3.0 mass % of titanium. The manganese dioxide with such a titanium content has a larger specific surface area and increases the reaction efficiency. Thus, the load characteristics of the alkali battery can be improved further.

The conductive agent for the positive electrode mainly is a carbon material such as graphite, acetylene black, carbon black, or fibrous carbon. In particular, graphite is used preferably. The amount of the conductive agent may be at least 3 parts by mass with respect to 100 parts by mass of the positive active material. When the conductive agent is not less than the above lower limit, the conductivity of the positive electrode can be increased to enhance the reactivity of the active material, thus further improving the load characteristics. Since a reduction in the amount of the active material is not desirable, the conductive agent is preferably not more than 8.5 parts by mass with respect to 100 parts by mass of the positive active material.

The binder for the positive electrode may be, e.g., celluloses such as CMC or methylcellulose, polyacrylate such as soda salt or ammonium salt, a fluorocarbon resin such as polytetrafluoroethylene, or polyolefins such as polyethylene. If the binder is included in a large amount, it may give rise to problems of reducing the conductivity or the like. However, a small amount of the binder makes good contact between the conductive agent and the active material, and thus can improve the load characteristics of the battery. Specifically, the content of the binder in the positive mixture is preferably 0.1 to 1 mass %.

The electrolytic solution for the positive electrode is preferably an aqueous solution of a hydroxide of alkali metal (such as sodium hydroxide, potassium hydroxide, or lithium hydroxide), and more preferably an aqueous solution of potassium hydroxide. In the case of the aqueous solution of potassium hydroxide, the concentration of potassium hydroxide is preferably 45 mass % or more, and more preferably 50 mass % or more. By using the alkaline electrolytic solution with such a concentration, the positive mixture can be uniform and formed into a high-density molded positive mixture. Therefore, the conductivity of the whole molded positive mixture can be increased, and the load characteristics of the battery can be improved. The upper limit of the potassium hydroxide concentration is preferably 60 mass %.

Electrolytic Solution

In the cylindrical alkaline battery of this embodiment, as shown in FIG. 1, the positive electrode and the negative electrode, together with a separator, are sealed in the positive outer can. As described above, both the positive mixture of the positive electrode and the negative mixture of the negative electrode include the alkaline electrolytic solution. However, there may be a shortage of liquids only with the alkaline electrolytic solutions in the positive and negative mixtures. Thus, it is desirable that an additional electrolytic solution be injected into the battery and absorbed by the separator or the positive electrode.

The electrolytic solution to be injected and absorbed by the separator or the positive electrode is preferably an aqueous solution of a hydroxide of alkali metal (such as sodium hydroxide, potassium hydroxide, or lithium hydroxide), and more preferably an aqueous solution of potassium hydroxide. In the case of the aqueous solution of potassium hydroxide, the concentration of potassium hydroxide is preferably 33.5 mass % or less in terms of improving the load characteristics of the battery or suppressing heat generation when the battery is short-circuited. On the other hand, the degradation of the battery characteristics during storage at high temperatures decreases with an increase in the potassium hydroxide concentration. Therefore, the potassium hydroxide concentration is preferably 28 mass % or more, and more preferably 30 mass % or more.

To prevent corrosion (oxidation) of the zinc-based particles and improve the effect of suppressing degradation of the battery characteristics during storage, it is desirable that a zinc compound be included in at least one selected from the electrolytic solution used for the positive mixture, the electrolytic solution used for the negative mixture, and the electrolytic solution injected additionally into the battery. The zinc compound may be a soluble compound such as a zinc oxide, zinc silicate, zinc titanate, or zinc molybdate. In particular, a zinc oxide is used preferably. The concentration of the zinc compound in any of the above electrolytic solutions may be, e.g., 1.0 to 4.0 mass %.

For the cylindrical alkaline battery of the present invention, it is preferable that the total moisture content in the battery is 0.23 to 0.275 g per 1 g of the positive active material, thereby ensuring the moisture required for a reaction to achieve excellent operating characteristics. The moisture content can be controlled by the amount of each of the electrolytic solutions.

Separator

The separator used for the cylindrical alkaline battery of this embodiment is not particularly limited, and may be, e.g., vinylon-rayon nonwoven fabric, vinylon-rayon mixed paper, polyamide nonwoven fabric, polyolefin-rayon nonwoven fabric, vinylon paper, vinylon-linter pulp paper, or vinylon-mercerized pulp paper. Moreover, the separator may be a laminate of a hydrophilic microporous polyolefin film (such as a microporous polyethylene film or microporous polypropylene film), a cellophane film, and a liquid-absorbing layer such as vinylon-rayon mixed paper.

The cylindrical alkaline battery of this embodiment uses the positive outer can formed of a steel plate having a soft nickel-plating layer on both sides, and thus is superior in long-term storage stability and also can suppress a leakage of the alkaline electrolytic solution. By taking advantage of these characteristics, the cylindrical alkaline battery is applicable to a power source of various remote controllers or clocks that need reliability over a long period of time.

Next, the present invention will be described in detail by way of examples.

In each of the following examples, the surface roughness Ra and the width of the exposed portions of the metal plate in the portion of the positive outer can that comes into contact with the sealing member were measured by the methods below.

Measurement of the Surface Roughness

The surface roughness Ra of the portion of the positive outer can that comes into contact with the sealing member was measured with a surface roughness measuring device (“Surftest SJ-201” manufactured by Mitsutoyo Corporation) at 0.8 mm cutoff.

Measurement of the Width of the Exposed Portions of the Metal Plate

The width of the exposed portions of the metal plate (i.e., the steel plate in each of the following examples) present in the portion of the positive outer can that comes into contact with the sealing member was measured by surface observation (magnification: 500×) with a microscope.

### EXAMPLE 1

A positive mixture was produced by mixing manganese dioxide (positive active material) having a moisture content of 1.6 mass %, graphite (conductive agent), polytetrafluoroethylene powder (binder), and an alkaline electrolytic solution (56 mass % of aqueous solution of potassium hydroxide containing 2.9 mass % of zinc oxide) for preparing the positive mixture at a mass ratio of 87.6:6.7:0.2:5.5 at 50° C. In the positive mixture, graphite was 7.6 parts by mass per 100 parts by mass of manganese dioxide. The potassium hydroxide concentration in the electrolytic solution of the positive mixture was 44.6 mass % in view of the moisture content of manganese dioxide.

Then, a gel negative mixture was produced by mixing zinc alloy particles (negative active material) including 0.05 mass % of indium, 0.05 mass % of bismuth, and 0.005 mass % of aluminum, polyacrylic soda (gelling agent), and an alkaline electrolytic solution (33.5 mass % of aqueous solution of potassium hydroxide containing 2.2 mass % of zinc oxide) for preparing the negative mixture at a mass ratio of 39:0.2:0.2:18. The zinc alloy particles had an average particle size of 109 μm and passed through an 80-mesh sieve. Moreover, the zinc alloy particles passing through a 200-mesh sieve was 20 mass % of the total amount of the zinc alloy particles, and their bulk density was 2.63 g/cm³.

A positive outer can was produced in the following manner. A killed steel plate with a thickness of 0.25 mm, a surface roughness Ra of 0.3, and a G. S. No. of 9.5 was used as a metal plate for the positive outer can. A soft nickel-plating layer with a thickness of 1.5 μm was deposited on both sides of the killed steel plate, thus providing a double-sided soft nickel-plated steel plate. The plating was performed in a dull electroplating bath (component concentration: 300 g/L of nickel sulfate, 45 g/L of nickel chloride, and 45 g/L of boric acid; pH: 4; bath temperature: 60° C.).

The double-sided soft nickel-plated steel plate was cut into a circular blank, and then drawn by pressing with a punch while transferring the blank to dies having successively smaller draw diameters, so that the bottom reduced its diameter gradually and the side wall increased its height, thus forming a positive outer can 1 with the shape as shown in FIG. 1. This process is so-called transfer drawing.

In the positive outer can 1, the sealing portion 10 had a thickness of 0.25 mm, and the body 20 had a thickness of 0.16 mm. Moreover, the positive outer can 1 was made slightly thicker in the positive terminal 1b than in the body 20 so as to prevent a dent of the positive terminal 1b when the battery was dropped. Using the positive outer can 1, an alkaline battery with the structure as shown in FIG. 1 was produced in the following manner.

The positive mixture was press-molded into a hollow cylinder, and subsequently was placed in the positive outer can 1 as a positive electrode 2. Specifically, the positive mixture was press-molded into a hollow cylinder with an inner diameter of 9.1 mm, an outer diameter of 13.7, and a height of 13.9 mm, thus providing a molded positive mixture (density: 3.21 g/cm³). Three molded positive mixtures were inserted in the positive outer can 1 by putting one on top of another. The total amount of the positive mixture was 11 g. Then, a groove was formed at a position 3.5 mm away from the open end of the positive outer can 1 in its height direction. To improve the contact between the positive outer can 1 and the sealing member 6, pitch was applied to the inside of the positive outer can 1 up to the position of the groove.

Next, nonwoven fabric that was made of acetalized vinylon fibers and cellulose fibers (“Tencel” manufactured by Courtaulds) and had a thickness of 100 μm and a basis weight of 30 g/m² was wound in three layers to make a tube, and the bottom of the tube was bent and fused thermally, resulting in a cup-shaped separator 3 with one end closed. The separator 3 was placed inside the positive electrode 2 located in the positive outer can 1, and 1.35 g of alkaline electrolytic solution (33.5 mass % of aqueous solution of potassium hydroxide containing 2.2 mass % of zinc oxide) was injected into the separator 3. Then, the separator 3 was filled with 5.74 g of the negative mixture as a negative electrode 4. In this case, the total moisture content in the battery was 0.261 g per 1 g of the positive active material.

Next, a negative current collector 5 made of tinned brass was welded to a negative terminal plate 7. The negative terminal plate 7 was formed by punching and press working of a nickel-plated steel plate and had a thickness of 0.4 mm. The negative current collector 5 welded to the negative terminal plate 7 was combined with a sealing member 6 made of nylon 0.66. The negative current collector 5, which was welded to the negative terminal plate 7 and combined with the sealing member 6, was inserted into the center of the negative electrode 4 and caulked from outside of the open end 1a of the positive outer can 1 by spinning. Consequently, the negative terminal plate 7 was fixed to the open end 1a of the positive outer can 1 via the sealing member 6, thus providing an AA-size alkaline battery. An insulator 8 made of nylon 66 was arranged between the positive outer can 1 and the negative terminal plate 7 to prevent a short circuit. In this manner, the alkaline battery of Example 1 was produced.

The surface roughness Ra of a portion of the positive outer can 1 that comes into contact with the sealing member 6 of the alkaline battery in this example was 1.85. In the portion of the positive outer can 1 that comes into contact with the sealing member 6, there were exposed portions of the steel plate due to cracks of the soft nickel-plating layer in the direction of the cylinder axis of the positive outer can 1, and the maximum width of the exposed portions of the steel plate in the direction perpendicular to the cylinder axis was 86 μm.

### EXAMPLE 2

An alkaline battery was produced in the same manner as Example 1 except that a killed steel plate with a G. S. No. of 9.9 was used.

The surface roughness Ra of a portion of the positive outer can 1 that comes into contact with the sealing member 6 of the alkaline battery in this example was 1.18. In the portion of the positive outer can 1 that comes into contact with the sealing member 6, there were exposed portions of the steel plate due to cracks of the soft nickel-plating layer in the direction of the cylinder axis of the positive outer can 1, and the maximum width of the exposed portions of the steel plate in the direction perpendicular to the cylinder axis was 44 μm.

### EXAMPLE 3

An alkaline battery was produced in the same manner as Example 1 except that a killed steel plate with a G. S. No. of 10.3. was used.

The surface roughness Ra of a portion of the positive outer can 1 that comes into contact with the sealing member 6 of the alkaline battery in this example was 0.67. In the portion of the positive outer can 1 that comes into contact with the sealing member 6, as shown in FIG. 3, there were exposed portions 40 of the steel plate due to cracks of the soft nickel-plating layer 30 in the direction of the cylinder axis of the positive outer can 1, and the maximum width of the exposed portions 40 of the steel plate in the direction perpendicular to the cylinder axis was 20 μm.

### COMPARATIVE EXAMPLE 1

An alkaline battery was produced in the same manner as Example 1 except that a killed steel plate with a G. S. No. of 8.4 was used.

The surface roughness Ra of a portion of the positive outer can 1 that comes into contact with the sealing member 6 of the alkaline battery in this example was 2.09. In the portion of the positive outer can 1 that comes into contact with the sealing member 6, as shown in FIG. 4, there were exposed portions 40 of the steel plate due to cracks of the soft nickel-plating layer 30 in the direction of the cylinder axis of the positive outer can 1, and the maximum width of the exposed portions 40 of the steel plate in the direction perpendicular to the cylinder axis was 130 μm.

The alkaline batteries of Examples 1-3 and Comparative Example 1 were evaluated as follows.

Evaluation of Leakage Resistance

While 10,000 batteries for each example were stored at 45° C. for 24 hours, it was decided whether a leakage of the alkaline electrolytic solution occurred or not. The decision was made by visual observation. Table 1 shows the results.

Evaluation of Discharge Characteristics

Using five batteries for each example, a pulse discharge test was performed with a discharge current of 2.0 A by repeating the cycle of 2-second discharge per minute at 58-second intervals. The number of discharge cycles was counted every time the 2-second discharge per minute was finished, and the average number of times the pulse discharge continued for 2 seconds was determined to evaluate the load characteristics. This evaluation means that the load characteristics of the battery are improved with increasing the number of times the battery can perform pulse discharge (pulse discharge number). In the batteries of Examples 1-3 and Comparative Example 1, there was no difference in the pulse discharge number, and thus the batteries were considered to have the same discharge characteristics.

TABLE 1

| | | | Maximum width | |
|---|---|---|---|---|
| | | Surface | of exposed | |
| | G.S. No. of | roughness | portions of steel | |
| | steel plate | Ra | plate (μm) | Leakage |
| Example 1 | 9.5 | 1.85 | 86 | zero |
| Example 2 | 9.9 | 1.18 | 44 | zero |
| Example 3 | 10.3 | 0.67 | 20 | zero |
| Comparative | 8.4 | 2.09 | 130 | 95 batteries |
| Example 1 | | | | |

In Table 1, the surface roughness Ra and the maximum width of the exposed portions of the steel plate are values as a result of measurement in the portion of the positive outer can that comes into contact with the sealing member.

In the batteries of Examples 1-3, as can be seen from Table 1, the G. S. No. of the nickel-plated steel plate of the positive outer can is within the range defined by the present invention. Both the surface roughness Ra and the width of the exposed portions of the steel plate also are in the range of predetermined values. Moreover, no leakage occurs during storage, and therefore it is apparent that these batteries are superior in long-term storage stability. In the batteries of Comparative Example 1, the G. S. No. of the nickel-plated steel plate of the positive outer can is outside the range defined by the present invention. Neither the surface roughness Ra nor the width of the exposed portions of the steel plate falls in the range of predetermined values. Moreover, a leakage occurs during storage, and therefore it is apparent that these batteries are inferior in storage stability.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A cylindrical alkaline battery comprising:
a positive outer can in the form of a cylinder having a bottom and an opening at its top;
a sealing member located around an inside edge of the opening; and
a negative terminal for sealing the opening along with the sealing member,
wherein the positive outer can houses electric power generating elements,
the negative terminal is caulked to the inside edge of the opening of the positive outer can via the sealing member,
the positive outer can is formed of a metal plate including crystal grains with a grain size number of 9 to 12;
a soft nickel-plating layer is deposited on both sides of the metal plate, and
a surface roughness Ra of a portion of the positive outer can that comes into contact with the sealing member is 2 or less.

2. The cylindrical alkaline battery according to claim 1, wherein a thickness of the soft nickel-plating layer is 1 to 3 μm.

3. The cylindrical alkaline battery according to claim 1, wherein the surface roughness Ra is 0.05 to 1.5.

4. The cylindrical alkaline battery according to claim 1, wherein the grain size number is 9 to 10.

5. The cylindrical alkaline battery according to claim 1, wherein P and S contained in the soft nickel-plating layer are each not more than 100 ppm by mass.

6. A cylindrical alkaline battery comprising:
a positive outer can in the form of a cylinder having a bottom and an opening at its top;
a sealing member located around an inside edge of the opening; and
a negative terminal for sealing the opening along with the sealing member,
wherein the positive outer can houses electric power generating elements,
the negative terminal is caulked to the inside edge of the opening of the positive outer can via the sealing member,
the positive outer can is formed of a metal plate including crystal grains with a grain size number of 9 to 12,
a soft nickel-plating layer is deposited on both sides of the metal plate, and
in a portion of the positive outer can that comes into contact with the sealing member, there are exposed portions of the metal plate due to cracks of the soft nickel-plating layer in a direction of the cylinder axis of the positive outer can, and a width of the exposed portions of the metal plate in a direction perpendicular to the cylinder axis is 100 μm or less.

7. The cylindrical alkaline battery according to claim 6, wherein a thickness of the soft nickel-plating layer is 1 to 3 μm.

8. The cylindrical alkaline battery according to claim 6, wherein the width of the exposed portions of the metal plate in the direction perpendicular to the cylinder axis is 10 to 50 μm.

9. The cylindrical alkaline battery according to claim 6, wherein the grain size number is 9 to 10.

10. The cylindrical alkaline battery according to claim 6, wherein P and S contained in the soft nickel-plating layer are each not more than 100 ppm by mass.

11. A cylindrical alkaline battery comprising:
a positive outer can in the form of a cylinder having a bottom and an opening at its top;
a sealing member located around an inside edge of the opening; and
a negative terminal for sealing the opening along with the sealing member,
wherein the positive outer can houses electric power generating elements,
the negative terminal is caulked to the inside edge of the opening of the positive outer can via the sealing member,
the positive outer can is formed of a metal plate including crystal grains with a grain size number of 9 to 12,
a soft nickel-plating layer is deposited on both sides of the metal plate,
a surface roughness Ra of a portion of the positive outer can that comes into contact with the sealing member is 2 or less, and
in the portion of the positive outer can that comes into contact with the sealing member, there are exposed portions of the metal plate due to cracks of the soft nickel-plating layer in a direction of the cylinder axis of the positive outer can, and a width of the exposed portions of the metal plate in a direction perpendicular to the cylinder axis is 100 μm or less.

12. The cylindrical alkaline battery according to claim 11, wherein a thickness of the soft nickel-plating layer is 1 to 3 μm.

13. The cylindrical alkaline battery according to claim 11, wherein the surface roughness Ra is 0.05 to 1.5.

14. The cylindrical alkaline battery according to claim 11, wherein the width of the exposed portions of the metal plate in the direction perpendicular to the cylinder axis is 10 to 50 μm.

15. The cylindrical alkaline battery according to claim 11, wherein the grain size number is 9 to 10.

16. The cylindrical alkaline battery according to claim 11, wherein P and S contained in the soft nickel-plating layer are each not more than 100 ppm by mass.
